(19) United States
(12) Patent Application Publication
(10) Pub. No.: US 2012/0235435 A1
(43) Pub. Date: Sep. 20, 2012

(54) Method and apparatus for accessing ADL devices

(76) Inventor: Clay Cacas, Terrell, TX (US)

(21) Appl. No.: 13/374,370

(22) Filed: Dec. 27, 2011

Related U.S. Application Data
(60) Provisional application No. 61/465,076, filed on Mar. 15, 2011.

(51) Int. Cl. B25J 15/06; B66F 19/00

(52) U.S. Cl. 294/190

(57) ABSTRACT

An apparatus and method that allows the access and use of assistive living tools. The apparatus includes a magnet attached to a flexible rod with a clamp attached to the opposite end from the magnet. Detachable small metal strips are attached to ADLS or other devices allowing the device to be supported by the magnet for access. The device can easily be removed from the magnet for use and can easily be replaced to the magnet. Devices, such as a TV remote control, cell phones, etc. could be attached to the rod making them accessible to operate with a mouth stick. This device allows unassisted access to a pencil, a paintbrush, a control stick, or a straw, etc. by persons with limited mobility.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING

Not Applicable

### FIELD OF THE INVENTION

This invention relates generally to an apparatus for assisting disabled persons, and more particularly, to an apparatus that assist disabled persons to access and use assisted living tools.

### BACKGROUND OF INVENTION

It is difficult for a disabled person seated in a wheelchair or other ambulatory to use a keyboard or to get a drink, without the use of some type of assisted living tool or device. Similarly it is difficult for persons using ambulatory devices to access these devices without the aid of another person. There are some products available, designed to be used for these tasks, however these products are not easily accessed and are difficult to use. Without being able to access a drinking straw or the drinking tube from a water pack, disabled persons often suffer from kidney infections and other renal problems due to low fluid intake.

There exists a need for a novel apparatus having new features that allows a disabled person to access and use assisted living tools without assistance from another person.

### BRIEF SUMMARY OF THE INVENTION

The present invention provides an apparatus that allows unassisted access to assistive living tools which advantageously allows persons in a wheelchair or other form of handicap devices to access and use assistive living tools, as well as a drinking tube from a water pack. Allowing the person to be more independent and improving their quality of life.

The present invention is made up of the following elements:

1. A flexible rod with magnet at one end.

2. A clamp for attaching the rod.

3. Small metal strips to attach to any device to make accessible.

The invention consists of a flexible rod that has a magnet attached at one end and at the opposite end of the rod a clamp attached for securing it in a fixed position. The above described apparatus enables the occupant of a wheelchair or other form of handicap device to access and use assistive living tools and return the tool when not in use, without aid from another person. An object of the present invention is to provide an improved method and an apparatus that satisfies the above mentioned need.

It is another object of the present invention to provide a novel apparatus that will be affordable and can be attached to a wheelchair or other handicapped device. The apparatus must be adjustable and have enough support to attach a cup holder that will hold a glass of liquid in a position that can be accessed with the straw after it is removed from the magnet. The magnet can hold a mouth stick or a similar device that could be used on a keyboard or a TV remote control that could also be supported on the flexible rod to allow the person to control a TV without the aid of another person.

These and other features will be in part apparent, and in part pointed out hereinafter.

A better under standing of the objects, advantages, feature, properties and relationships of the invention will be obtained from the following detailed description and accompanying drawings which set forth an illustrative embodiment and is indicative of the various ways in which the principles of the invention may be employed.

### BRIEF DESCRIPTION OF THE DRAWINGS

Embodiments of the present invention are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 Side view of present invention shown with preferred embodiment;

FIG. 2 Front view of present invention shown with preferred embodiment;

FIG. 3 View of Metal Strips

### DETAILED DESCRIPTION OF THE INVENTION

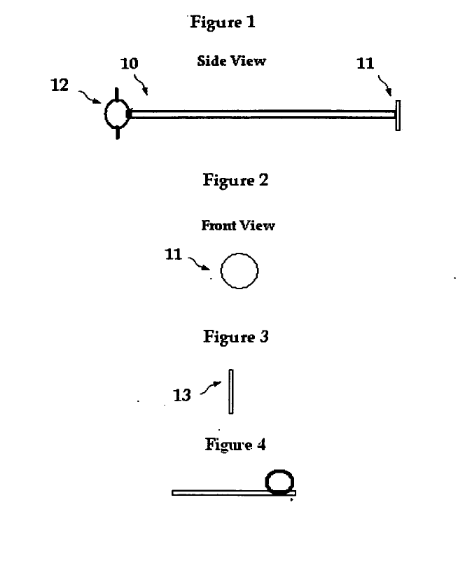

A system and apparatus that helps a disabled person access needed devices without the assistances from a person is indicated generally in the FIGS. 1 and 2. FIG. 1 is a side view of the apparatus that is constructed by attaching a magnet (11) to a flexible rod (10) with a length that will be determined by each individual's needs and type of ambulatory device that it will be attached to. The Clamp (12) will attach the flexible rod to the ambulatory device. The metal strips (13) are wrapped around the device to be used by the person when needed. This allows the device to be held in a ready to use position by the magnet (11), an example would be a drinking straw. The flexible rod (10) is secured on the wheelchair or other handicapped device in a position easily reached by the mouth. The metal strips (13) are approximately 2″ long and pliable. The strips are wrapped around the assistive living device enabling it to be held in place by the magnet (11) being 1″ in diameter or another size depending on needs. The person uses the mouth to remove the item from the magnet (11) for use and replaces it back on the magnet (11) when finished. (FIG. 4) A cup holder can be attached to the rod at any position that that allows access with the straw.

The preceding description is for the preferred embodiment of the present invention it is understood that many variations exist, accordingly the sprit and scope of the invention are not to be limited by the above description. An example would be the apparatus could more than one magnet allowing access to more than one device. Another example: the apparatus could be attached to a desk.

The invention claimed is:

1. An assistive living device comprising of: an adjustable rod, a magnet attached to the rod, and a clamp attached to the rod for securing the device for use.

2. A assistive living system that has the device in claim 1 and metal strips that can be attached to any tool to allow that tool to be secured to the magnet.

3. A assistive living system that has the device in claim 1 with a cup holder attached to the rod.

4. A assistive living system that has the device in claim 1 that has an attachment that can support a TV remote control or a cell phone that allows a person to access these devices with a mouth stick or similar tool.

5. An assistive living that has the device in claim 1 with the features of claims 2, 3, and 4.
